(19) United States
(12) Patent Application Publication
(10) Pub. No.: US 2011/0251897 A1
(43) Pub. Date: Oct. 13, 2011

(54) Online Shopping Circulars

(75) Inventors: Jeffrey Scott Litvack, New York, NY (US); Soin Anne Park, Brooklyn, NY (US); David J. Buckley, JR., Milton, MA (US); Benjamin Turlough Mosse, Thomastown (IE); Sandra Peters, Encinitas, CA (US); Philip Ceasar Flores Te, La Mesa, CA (US)

(73) Assignee: THE ASSOCIATED PRESS, New York, NY (US)

(21) Appl. No.: 13/076,260

(22) Filed: Mar. 30, 2011

Related U.S. Application Data
(60) Provisional application No. 61/342,365, filed on Apr. 12, 2010.

(51) Int. Cl. G06Q 30/00

(52) U.S. Cl. 705/14.58; 705/14.73; 705/14.71

(57) ABSTRACT

There is provided a system and method for user interfaces to navigate online shopping circulars. There is provided a method comprising retrieving circular data, presenting the circular data arranged by sorting parameters, receiving a request to obtain a product, and initiating a transaction for the requested product with a retailer. The sorting parameters may include parameters such as retailer bids for enhanced visibility, thereby providing increased monetization opportunities. The sorting parameters may also include flexible preset or user defined filtering options, allowing users to enjoy an engaging and streamlined shopping experience. The online shopping circulars may be implemented as a module for online media content, such as a news site or an entertainment portal.

### RELATED APPLICATIONS

This application claims priority to U.S. Provisional Application No. 61/342,365, filed on Apr. 12, 2010, which is hereby incorporated by reference in its entirety.

### BACKGROUND OF THE INVENTION

1. Field of the Invention

The present invention relates generally to user interfaces. More particularly, the present invention relates to user interfaces for navigating online shopping circulars.

2. Background Art

Advertising or shopping circulars such as free standing inserts (FSIs), mailers, catalogues, and other materials comprise important marketing tools for retailers and brands while providing effective revenue streams for content and media providers. Shoppers are always on the lookout for coupons and promotions to stretch the value of their dollars, and advertising circulars such as FSIs provide a centralized location to find valuable deals in an attractively presented format. Unfortunately, it is inconvenient to browse through such circulars on the go, particularly if a shopper is interested in shopping from several different retailers or brands.

Conventionally, distribution and consumption of news and entertainment content along with advertising content was by physical media delivered on a periodic basis, such as by newspapers or magazines. However, with the recent proliferation of affordable Internet access devices such as smart phones, personal media players, tablet computers, laptop computers, and other devices, users are increasingly accessing the Internet for anywhere, anytime media consumption. While news and entertainment content have adapted well for online spaces through dynamic websites and mobile applications, advertising circulars have not adapted in a similar manner to exploit the possibilities provided by online spaces. For example, advertising materials may be simply reprinted on the web without any alterations from their print versions, providing no added value for users.

Accordingly, there is a need to overcome the drawbacks and deficiencies in the art by providing a way for users to browse advertising circulars adapted and optimized for an online context.

### SUMMARY OF THE INVENTION

There are provided systems and methods for user interfaces to navigate online shopping circulars, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1A illustrates a system for implementing online shopping circulars, according to an embodiment of the present invention;

FIG. 1B illustrates a display of a device showing a user interface for browsing online shopping circulars of multiple retailers, according to an embodiment of the present invention;

FIG. 2 illustrates a display of a device showing a user interface for browsing online shopping circulars of a single retailer, according to an embodiment of the present invention;

FIG. 3 illustrates a display of a device showing a user interface for browsing online shopping circulars by category, according to an embodiment of the present invention;

FIG. 4 illustrates a display of a device showing a shopping list user interface for online shopping circulars, according to an embodiment of the present invention;

FIG. 5 illustrates a display of a device showing an item detail user interface for online shopping circulars, according to an embodiment of the present invention;

FIG. 6 illustrates a display of a device showing an user interface for searching online shopping circulars, according to an embodiment of the present invention; and

FIG. 7 shows a flowchart describing the steps, according to one embodiment of the present invention, by which a user interface for navigating online shopping circulars may be provided.

### DETAILED DESCRIPTION OF THE INVENTION

The present application is directed to systems and methods for user interfaces to navigate online shopping circulars. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

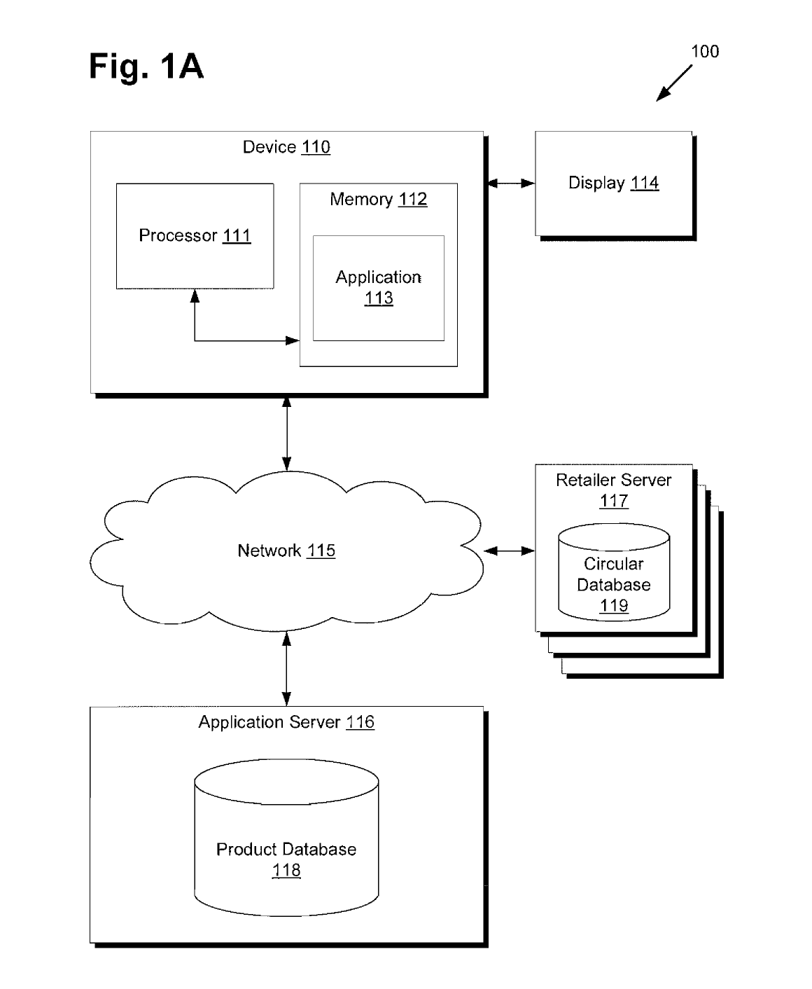

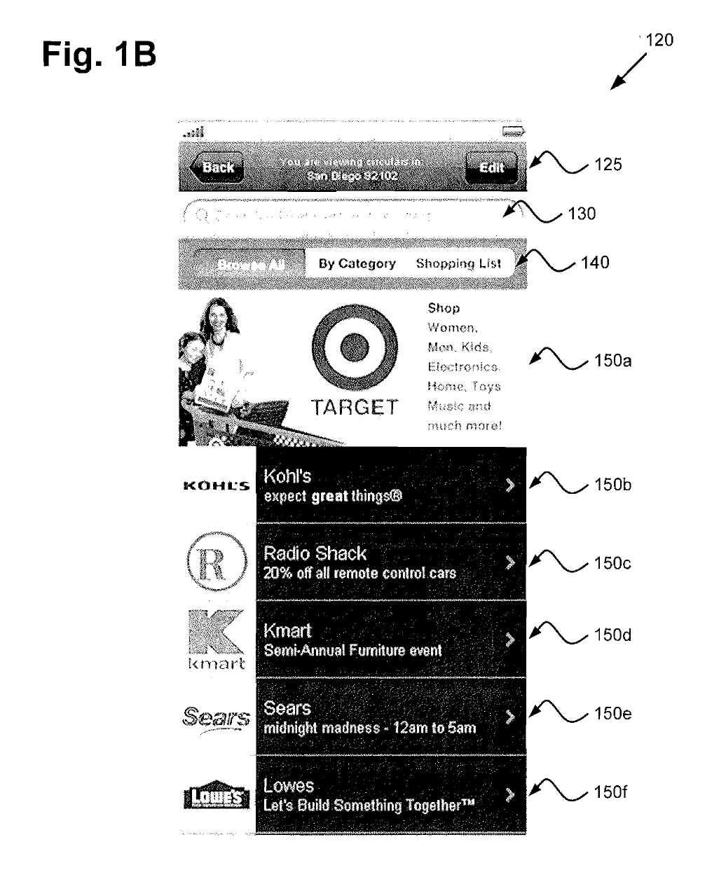

FIG. 1A illustrates a system for implementing online shopping circulars, according to an embodiment of the present invention. System 100 of FIG. 1A includes device 110, display 114, network 115, application server 116, and retailer server 117. Device 110 includes processor 111, memory 112, and application 113. Application server 116 includes product database 118. Retailer server 117 includes circular database 119. Device 110 may be, for example, a mobile phone, a personal media player, a tablet computer, a laptop computer, or another Internet access device. Network 115 may comprise a public network such as the Internet. As shown in system 100, device 110 is connected to display 114 and network 115. Application 113 executing on processor 111 of device 110 may comprise a media consumption application such as a news article reader, which includes an online shopping circular module.

For example, application 113 may comprise a news reading application providing an icon or splash page to access an associated online shopping circular module. The icon or splash page may include a message such as “Check out the latest deals from your favorite retailers”, or a similar call to action. Once activated, the online shopping circular module can then present a convenient and intuitive interface for users to browse through different retailers and available promotions, to create and save a shopping cart of items, and to find nearby locations of participating retailers. In this manner, users can plan an optimized route of shopping while enjoying the experience of finding and capitalizing on limited time discounts and promotions.

Data for populating and supporting the online shopping circular module may be retrieved from application server 116, which may host databases for application 113 such as product database 118, and retailer server 117, for which one or more servers may exist for each participating retailer. As shown in diagram 100 of FIG. 1A, each retailer server 117 may include a circular database 119, which may contain data for product promotions organized into specific circulars with limited time periods of validity at the associated retailer. Although only a single device 110 and a single application server 116 are shown for simplicity, alternative embodiments may serve multiple devices to support several concurrent users and use multiple application servers for load balancing.

FIG. 1B illustrates a display of a device showing a user interface for browsing online shopping circulars of multiple retailers, according to an embodiment of the present invention. Upon activation of the online shopping circular module, an interface similar to that shown in display 120 of FIG. 1B may be presented to the user as a default view, where all nearby participating retailers are listed under the “Browse All” category. Display 120 of FIG. 1B corresponds to display 114 in FIG. 1A. The default ordering of the retailers may, for example, be negotiated as a placement premium between advertisers, or retailers purchasing advertising space, and content providers, or the administrators of the news article reader application.

Thus, for example, retailers can place bids for placement in the online shopping circular module. After all bids are received for a given time period, retailers may then be sorted to display from the highest bids first when listed in the default ordering. These priorities may, for example, be stored within application server 116, which may then be retrieved by application 113 for use in prioritizing retailer placement. Retailer priority may be valid for a limited period of time, after which retailers may bid again for placement.

As shown at the top of display 120 of FIG. 1B, a series of navigation bars are presented to the user, including location bar 125, search bar 130, and category bar 140. Location bar 125 includes a “back” button, which may take the user to the last visited navigation screen. For example, if the user just arrived from the news reading application, then the back button would return the user to the particular article the user was previously reading. Location bar 125 also shows a presently selected location, which is shown as “San Diego 92102” in the example shown in FIG. 1B. By clicking on the “Edit” button in location bar 125, this location may be changed, for example by manually entering a city or ZIP code, by reading GPS coordinates, or by using network triangulation. The provision for manually changing the location may also allow users to browse circulars in distant locales, which may be useful for planning shopping trips during vacations or other excursions. The location may be stored within a non-volatile memory such as memory 112 of FIG. 1A so that subsequent launching of the online shopping circular can automatically use the stored location without requiring user input.

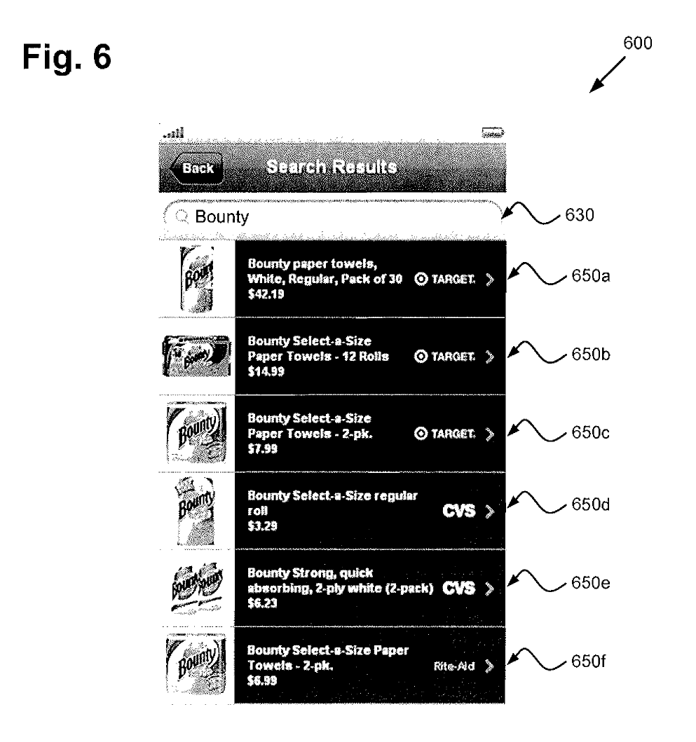

Moving down to search bar 130, the user is invited to “Search All Retailers' Active Offers.” Since the user interface shown in display 120 of FIG. 1B is directed towards all retailers, search bar 130 similarly searches through all retailers' offers or retailer names to find specific items or retailers. However, when the user interface is focused on a particular retailer, then search bar 130 may accordingly search through only that particular retailer. The user may, for example, type or write a search query using a physical or an on-screen keyboard and receive a list of results from participating retailers, as discussed in further detail below in conjunction with FIG. 6.

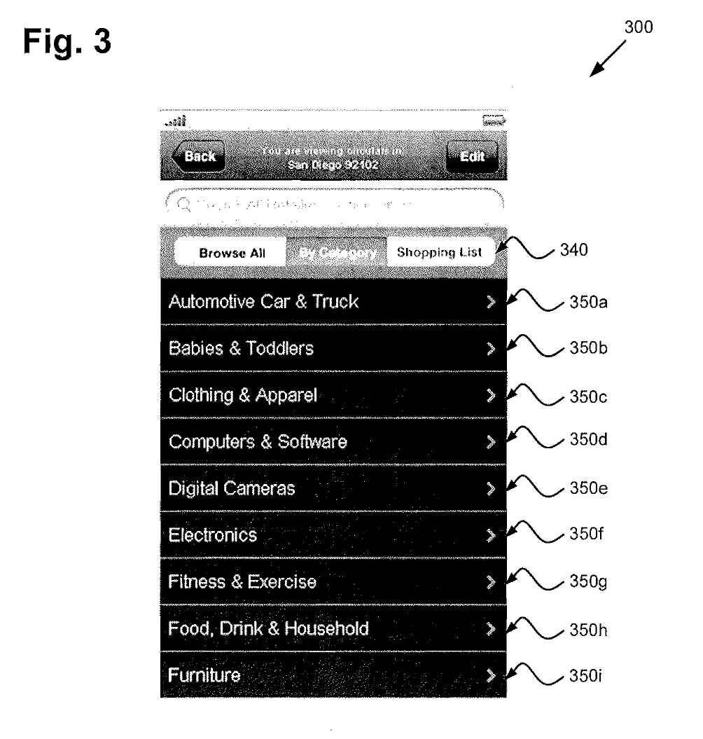

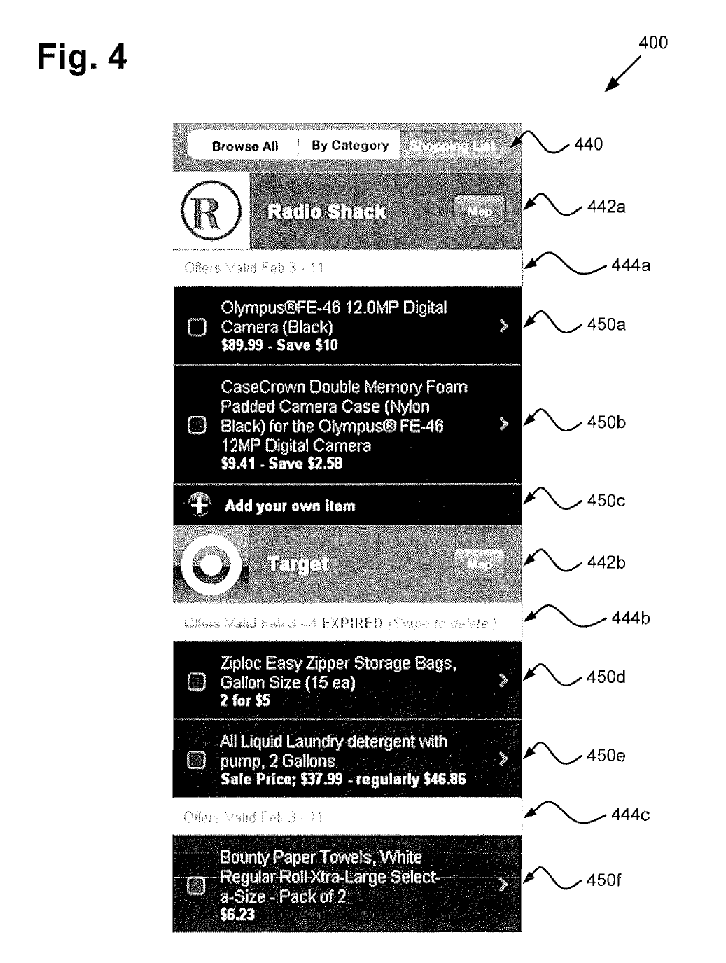

Moving down to category bar 140, the user may select from “Browse All”, “By Category”, and “Shopping List”. As shown in category bar 140, the “Browse All” category is selected by default. The “By Category” selection may list a number of broad merchandise and service categories, as discussed in further detail below in conjunction with FIG. 3. The “Shopping List” selection may display the shopping list of the user, as discussed in further detail below in conjunction with FIG. 4. The shopping list may be stored in a non-volatile memory such as memory 112 of FIG. 1A for persistence in subsequent instances of the online circular shopping module.

Next, a listing of retailers having a physical presence nearby the selected location, or San Diego 92102, and having active circular offers is shown to the user. Location proximity may be determined, for example, by using a radius range or by clustering of nearby cities or zip codes. As previously discussed, retailer placement may be negotiated as an additional paid for placement premium, where advertisers pay more to be placed higher or more prominently in default retailer listings. Thus, as shown in FIG. 1B, a limited number of featured retailers may be showcased, as demonstrated by the larger and more prominent entry for TARGET® in retailer listing 150a including an enlarged brand logo, graphic, and customizable text. Next in priority are retailer listings 150b through 150f, each including a smaller brand logo and a customizable text block such as a tagline, trademark, specific offer details, or a “door buster” announcement. Retailer listings placed visually higher, such as retailer listing 150b, may command greater prices than retailer listings placed visually lower, such as retailer listing 150f. Next, although omitted from FIG. 1B, more retailers may be listed below retailer listing 150f, which may for example include non-featured retailer listings each having only a simple line of text. Non-featured retailer listings may not be paid for placement and may thus be sorted by some other criteria, such as alphabetically. Featured retailers such as TARGET® may also be repeated within the non-featured retailer listings to provide a complete text listing.

Although the embodiments shown in FIG. 1B present only static text and graphics, alternative embodiments may also include animated images, movies, and other interactive elements. However, to provide an optimal and fast loading experience for users, heavy graphic and interactive elements may be purposely limited for bandwidth and processor load conservation. Additionally, while only large national retailers are shown in FIG. 1B, the concept can be applied to local or regional businesses such as local restaurants.

The online shopping circular application may also allow users to override the default retailer listing order. For example, users may flag particular retailers as favorite retailers, and these retailers may show with a higher listing priority in future viewings of the retailer listings. In this manner, retailers' desire for premium placement may be effectively balanced with users' desire for a flexible and customizable user interface.

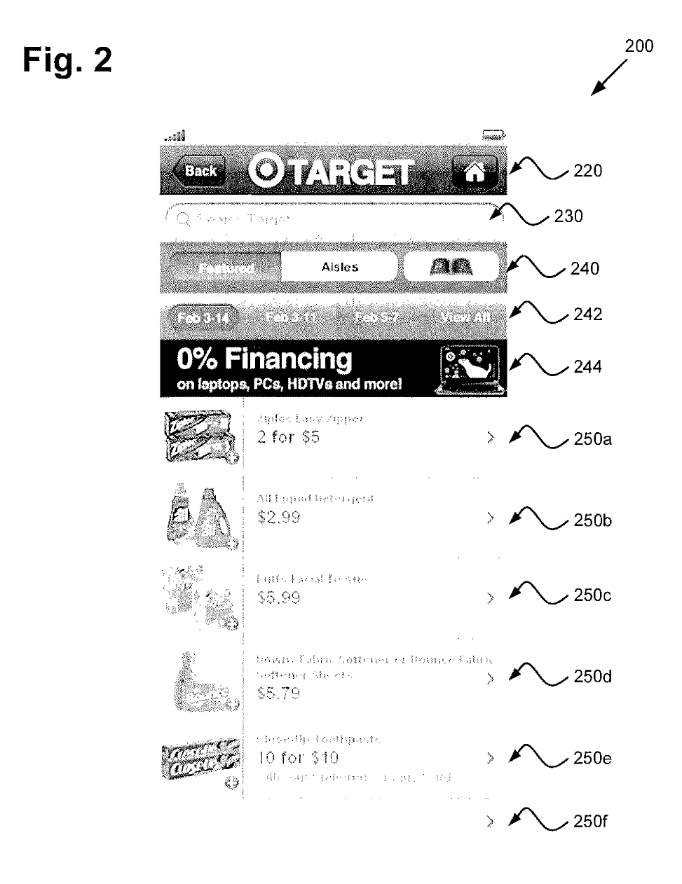

Moving to FIG. 2, FIG. 2 illustrates a display of a device showing a user interface for browsing online shopping circulars of a single retailer, according to an embodiment of the present invention. Display 200 corresponds to display 114 of FIG. 1A. For example, after clicking or touching retailer listing 150a in FIG. 1B, the user may be taken to an interface similar to that shown in display 200 of FIG. 2. The closest physical store according to the present location may be selected by default, but the user may override the selection if it is inconvenient.

As shown at the top of display 200 of FIG. 2, location bar 220 is now customized for the selected retailer, or TARGET®. The back button may return the user back to the complete retailer listing as in FIG. 1B, and the home icon may return the user back to the original news reader application. Search bar 230 is now restricted to searching from items within TARGET® only.

Category bar 240 now shows the “Featured” category, the “Aisles” category, and an icon for reading a traditional paper circular. The “Featured” category may show a list of retailer selected products and promotions, as shown in FIG. 2. The “Aisles” category may group items by physical aisle location or category, and optionally provide a map of the selected store layout, if available. The icon for the paper circular may show a digital version of the traditional paper circular, with pages navigable for example using a cover flow view. The cover flow view may be enhanced with interactivity, for example allowing users to click or touch to add items from the paper circular to the shopping list.

Circular selector 242 allows the selection of a particular circular or the viewing of all active circulars for a given retailer. As shown in circular selector 242, each circular may have a different time period of validity, which may partially or wholly overlap with other circulars. Circulars may for example be sorted such that circulars with the nearest expiring times are shown first in the list, or such that circulars with the earliest start date are shown first. Circulars that have already expired may be removed from circular selector 242. On the other hand, circulars that are not yet in effect may be listed to provide users with a preview of upcoming sales and events, for example up to one week in advance. Circulars may also be labeled and organized by particular themes or promotions. For example, in December, there may be a separate circular for Christmas and Hanukah each having different promotional items but overlapping time periods. Thus, if multiple promotions are in effect, users can easily navigate to particular promotions of interest, or view all promotions under the “View All” selection if desired.

Additionally, banner 244 may be provided as a space for retailers to call attention to particular retailer in-house services or promotions, or as open space for advertising partners. As shown in FIG. 2, banner 244 is presently displaying an in-house zero percent financing promotion for selected items that is exclusive to the TARGET® retailer.

After all the headers, the main content or listing of promotional items is provided, including item listings 250a through 250e. As shown, each item listing includes a thumbnail of the product, a title, and the special pricing or promotional offer. Associated e-coupons may also be listed here and automatically added with one click when adding the item to the shopping list. Additionally, the item listings may also list quantity limitations, such as one per customer, and any other limitations and requirements. For example, as shown in item listing 250e, the 10 for $10 offer is valid with a Preferred Savings Card. Such club, rewards, and loyalty cards can, for example, be associated with the user by scanning a barcode printed on the physical card using a camera of the Internet access device. Alternatively, a user account number or an alternative identifier such as a telephone number may be manually entered, or a magnetic stripe reader add-on might be attached to the Internet access device to read account data from the cards.

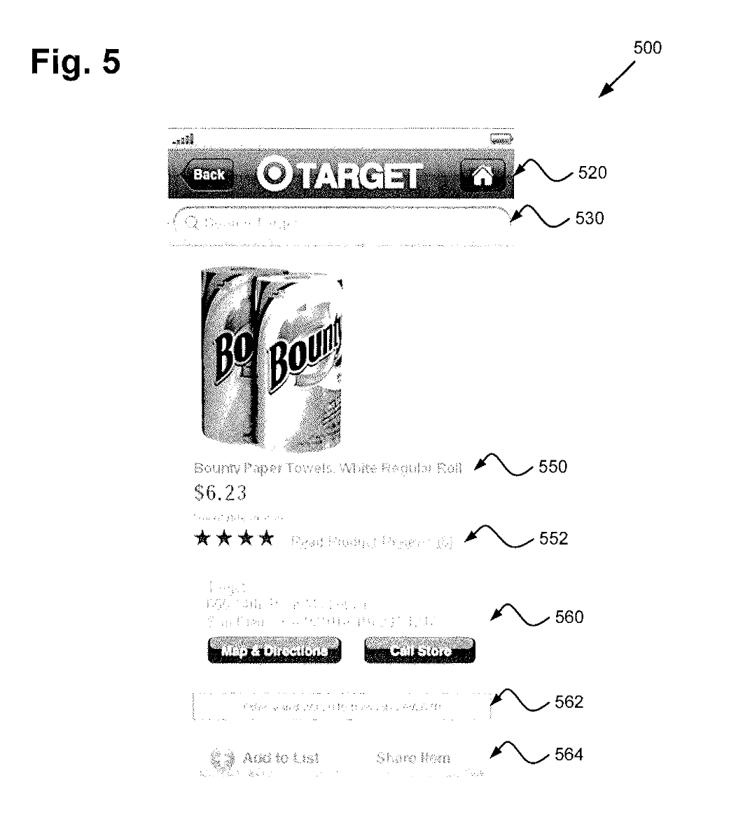

Assuming all item conditions and restrictions are met, the user may for example click on the plus icon shown in an image thumbnail to add a desired item to the user's shopping list. A pop-up window may appear to allow a desired quantity of items to be added. Clicking or swiping on the description or the right arrow for a particular item listing may take the user to a detailed item description page, as described below in conjunction with FIG. 5. Item listing 250f, the “View more items” selection, may reveal further available offers and/or regular items that are not presently on promotion.

Although the embodiment shown in FIG. 2 is organized around a vertical list view of items, alternative presentation embodiments may also be used as well. For example, items may be arranged in a matrix or grid view, by a full screen cover flow view, or by any other desired method of presentation.

Moving to FIG. 3, FIG. 3 illustrates a display of a device showing a user interface for browsing online shopping circulars by category, according to an embodiment of the present invention. Display 300 corresponds to display 114 of FIG. 1A. For example, after clicking or touching the “By Category” button in category bar 140 of FIG. 1B, the user may be taken to an interface similar to that shown in display 300 of FIG. 3. As shown by category bar 340 of FIG. 3, the “By Category” selection is now active.

As shown by category listings 350a through 350i, various broad categories are listed for the user to select from. The user interface may support swipe gestures to reveal additional categories by scrolling vertically. While the categories shown in FIG. 3 are grouped by product type, other grouping criteria may also be used. For example, one category might include only clearance items, whereas another category may include only the most popular or best-selling items. After selecting a particular category, featured items within the selected category may be retrieved from all participating retailers for displaying to the user. As with the retailer listing in FIG. 1B, the list of results may first be ordered using a default pay for placement scheme, and optionally customized by user preferences to display preferred retailers first. Additionally, the online shopping circular application may allow the user to further sort items within a category by particular criteria, such as alphabetically, by brand, by popularity or sales, or by user ratings. The list of items may appear similar to item listings 250a through 250f shown in FIG. 2, and may also use different presentation methods besides a vertically scrolling list.

Moving to FIG. 4, FIG. 4 illustrates a display of a device showing a shopping list user interface for online shopping circulars, according to an embodiment of the present invention. Display 400 corresponds to display 114 of FIG. 1A. For example, after clicking or touching the “Shopping List” button in category bar 140 of FIG. 1B, the user may be taken to an interface similar to that shown in display 400 of FIG. 4. As shown by category bar 440 of FIG. 4, the “Shopping List” selection is now active.

As shown by retailer headings 442a through 442b, the shopping list may be organized by retailer to facilitate route planning for making corresponding purchases in-store. Thus, map icons are displayed in retailer headings 442a and 442b to help the user locate the selected location for each retailer, which might be mapped and routed using GPS data, for example. Although not shown in FIG. 4, additional features such as route optimizing or minimizing may be provided to help reduce the total distance traveled between different retailers. The ordering of retailer headings may then be reorganized to correspond to an optimal route.

Within each retailer heading is a list of items associated with the particular retailer. These items may have been added in a present or a previous session, allowing items to carry over between sessions if they are not purchased. Additionally, wish list functionality may be provided, allowing shopping list items to be moved to a separate wish list. The user may keep items in the wish list and the application may, for example, notify the user if any new promotions are available for items in the wish list, providing the user a chance to move the item back to the shopping list to take advantage of future promotions. Optionally, push or SMS notifications may be provided to the user when items in the shopping list or the wish list have any new promotions available, when preferred retailers provide new circulars, or if existing promotions will soon expire. Summary notifications might also be provided on a periodic basis, such as featured promotions once per day or week. As with other persistent data stored by the application, the shopping list and wish list may be stored in a non-volatile memory such as memory 112 of FIG. 1A, Alternatively, the data may be stored “in the cloud,” or from servers accessible from network 115 or the Internet, such as application server 116 in FIG. 1A.

As shown by item listings 450a and 450b, each item listing may include an item description, details of the price or promotion, and a box for changing quantities, removing items, or marking items as already purchased. Clicking or touching a particular item listing may also bring up a detailed item description page, described in conjunction with FIG. 5 below. Item listing 450c may allow users to “Add your own item”, or to manually add an item that may be unlisted in the circulars.

As shown by circular headers 444a through 444c, after sorting by retailer headers, items may be further sorted into particular circulars having different periods of eligibility. Thus, as shown by circular headers 444b and 444c, shopping list items are first grouped by a circular that is valid from February 3 to 4 and then by a circular that is valid from February 3 to 11. Since the present date may, for example, be February 5, circular header 444b is marked as “EXPIRED”. However, the items are not automatically removed from the shopping list, as the user may still want to purchase the items at normal price, or the user may want to move the items to a wish list to wait for future promotions. If however, the user no longer wishes to purchase the items with expired offers, then the user may for example swipe circular header 444b as indicated to remove all associated expired items, or item listings 450d and 450e. Optionally, users may set an automatic expiration period for items to expire from a shopping list or wish list, such as one week.

When the user is ready to make an in-store purchase for a particular retailer, a button may be provided allowing the contents of the shopping list to be sent as an order in the commerce systems of the retailer. As previously discussed, the user's club or reward card membership details may also be stored and thus automatically associated for any such orders. Thus, when the user arrives at the store, the user need only retrieve the items listed in the shopping list and resolve payment at checkout. If the Internet access device is linked to payment credentials of the user, then a prepayment of the order may be resolved in advance. Optionally, the retailer may support the gathering and holding of ordered items in advance so that users need only pick up their prepared order rather than searching through the aisles for the individual items. If ordered items are not in stock, then rain checks may be issued at the retailer's discretion. The additional foot traffic into retail locations may advantageously encourage increased retailer buzz and impulse sales potential. Alternatively, home delivery or shipping may be supported, as traditionally provided for conventional e-commerce transactions. Once a purchase is finalized, the associated items may be removed from the user's shopping list.

Additional features that are not shown in FIG. 4 may be implemented as well. For example, shopping list sharing and synchronization may be implemented between different devices running the online shopping circular application or through other protocols such as e-mail or social networking, allowing friends and family to review and collaborate on shopping lists. A total dollar amount or percentage saved may be tallied from all items in the shopping list and presented to the user, providing high impact proof of money being saved. Recommended or suggested items based on existing items within the shopping list or past purchases may also be provided.

Additional location-based services may also be provided, which may be offered as an opt-in basis depending on relevant privacy policies in place. For example, if a user enters a particular retailer store location, as detected by user movement patterns provided by GPS data, relevant coupons of that retailer could be provided to the user. Additionally, an interactive map may show the location of the user within the physical layout of the store, and users may be able to touch a particular aisle to bring a listing of relevant promotions for that aisle.

Moving to FIG. 5, FIG. 5 illustrates a display of a device showing an item detail user interface for online shopping circulars, according to an embodiment of the present invention. Display 500 corresponds to display 114 of FIG. 1A. For example, after clicking on the “View more items” item listing 250f in FIG. 2 and clicking an item listing corresponding to BOUNTY® paper towels, the user may be taken to an interface similar to that shown in display 500 of FIG. 5. As shown by category bar 520 of FIG. 5 and search bar 530 of FIG. 5, the user interface remains associated with the selected TARGET® retailer as in FIG. 2.

As shown in display 500, the detailed description of the item provides several details such as item description 550, product review 552, store location 560, and time period 562. Item description 550 may include details such as the item name, price, offer details and/or requirements such as in-store only or limit one per customer, and online stock status or in-store stock quantities, if available. Product review 552 may include editorial and/or user reviews for the associated product. Store location 560 may indicate the selected physical store location for the presently selected retailer. As shown, buttons for navigating to and contacting the store are provided. Interaction bar 564 allows the displayed item to be added to the user's shopping list or shared with a friend or associate.

Additional features not shown in FIG. 5 may also be implemented as well. For example, if the Internet access device has access to a camera, a “confirm item” button may be provided, allowing the user to scan the UPC code of a physical product to confirm that the selected product is the correct product. For example, a promotion might be restricted to a certain size, flavor, color, or other variation, and the user may wish to confirm that a given item is indeed the correct item for a given promotion.

Moving to FIG. 6, FIG. 6 illustrates a display of a device showing an user interface for searching online shopping circulars, according to an embodiment of the present invention. Display 600 corresponds to display 114 of FIG. 1A. For example, after clicking on search bar 130 in FIG. 1B and typing the query “BOUNTY®”, the user may be taken to an interface similar to that shown in display 600 of FIG. 6.

The user may then specify a search term within search box 630. As shown by search results 650a through 650f, all items that match the search query “BOUNTY®” defined in search box 630 are listed, sorted by retailer. In a similar fashion as item listings 250a through 250e of FIG. 2, the user may click on a particular search result to view a detailed item listing similar to FIG. 5. From there, the user can add the item to the shopping list or perform another search. As with FIG. 1B, the default ordering of the retailers shown in the search results may be determined by pay for placement rules. Thus, as shown by search results 650a through 650c, results from the featured retailer TARGET® are shown first. As previously discussed, these default placement rules may be optionally overridden by user preferences. Thus, the retailers' desire for premium placement can be balanced against the users' desire to comparison shop.

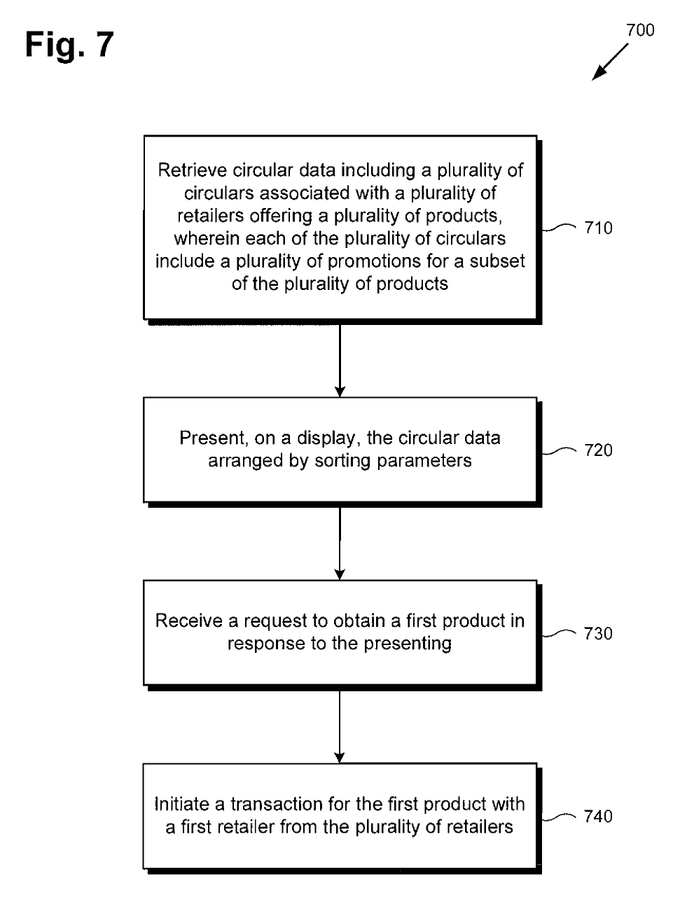

Moving to FIG. 7, FIG. 7 shows a flowchart describing the steps, according to one embodiment of the present invention, by which a user interface for navigating online shopping circulars may be provided. Certain details and features have been left out of flowchart 700 that are apparent to a person of ordinary skill in the art. For example, a step may comprise one or more substeps or may involve specialized equipment or materials, as known in the art. While steps 710 through 740 indicated in flowchart 700 are sufficient to describe one embodiment of the present invention, other embodiments of the invention may utilize steps different from those shown in flowchart 700.

Referring to step 710 of flowchart 700 in FIG. 7 and diagram 100 of FIG. 1A, step 710 of flowchart 700 comprises processor 111 of device 110 retrieving circular data including a plurality of circulars associated with a plurality of retailers offering a plurality of products, wherein each of the plurality of circulars include a plurality of promotions for a subset of the plurality of products. For example, product database 118 may contain data for the plurality of products offered by the plurality of retailers, where each retailer is associated with a particular commerce server such as retailer server 117. Retailer server 117 may then contain circular database 119, which may include a plurality of circulars associated with the retailer. Processor 111 of device 110 may then retrieve, over network 115, all available circulars from each circular database, such as circular database 119, of each retailer server, such as retailer server 117, and further retrieve any necessary product details from product database 118 of application server 116. Step 710 may be repeated periodically to retrieve new and updated circular data as time progresses.

For example, using diagram 200 of FIG. 2 as an example, if retailer server 117 is associated with the TARGET® retailer, then circular database 119 may contain at least three tables corresponding to the available circulars, or one circular for February 3-14, one circular for February 3-11, and one circular for February 5-7. The database table for the February 3-14 circular may then include records corresponding to the promotions shown as item listings 250a through 250e in diagram 200 of FIG. 2. Since the promotions only apply to a limited portion of a specific retailer catalog, the promotions apply only to a subset of the plurality of products referenced in product database 118. As shown in FIG. 2, a promotion may offer special prices or discounts, with or without conditions such as a minimum quantity or club membership. However, other types of promotions besides discounts may be offered, such as special edition or exclusive products, personalization, and retailer services such as installation assistance.

Referring to step 720 of flowchart 700 in FIG. 7 and diagram 100 of FIG. 1A, step 720 of flowchart 700 comprises processor 111 of device 110 presenting, on display 114, the circular data retrieved from step 710 arranged by sorting parameters. As previously discussed, the sorting parameters may include a default ordering of the retailers determined by competitive bidding, as shown in diagram 100 of FIG. 1B. The sorting parameters may also include ordering circulars by time periods of validity, as shown in diagram 200 of FIG. 2. Another sorting parameter may include proximity to device 110. For example, the search results 650a through 650f shown in diagram 600 of FIG. 6 may be ordered according to which retailers have a location closest to the user of device 110. Further, as shown by search box 630, the user may provide a user defined search term as a sorting parameter to filter the circular data. Besides user defined search terms, predefined selectable categories may also be used as sorting parameters, such as the categories presented in diagram 300 of FIG. 3 or category bar 240 of FIG. 2. Thus, a wide range of sorting parameters may be utilized to present the circular data retrieved from step 710 in an intuitive and helpful manner for users while retaining opportunities for monetization of online content, such as by competitive bidding of retailer visibility as previously described.

Referring to step 730 of flowchart 700 in FIG. 7 and diagram 100 of FIG. 1A, step 730 of flowchart 700 comprises processor 111 of device 110 receiving a request to obtain a first product in response to the presenting of the circular data in step 720. Thus, the user of device 110 may, after viewing display 114, request a specific product shown on display 114 as the first product. Processor 111 may then, for example, record a shopping list or wish list within memory 112, wherein the shopping list or wish list includes a reference to the first product. Notification alerts may be presented on display 114 to inform the user of the commencement or impending expiration of any promotions associated with the first product. Steps 720 and 730 may be repeated to populate the shopping list or wish list with multiple items.

Referring to step 740 of flowchart 700 in FIG. 7 and diagram 100 of FIG. 1A, step 740 of flowchart 700 comprises processor 111 of device 110 initiating a transaction for the first product requested in step 730 with a first retailer from the plurality of retailers. The first retailer may, for example, be also specifically requested in step 730, as the user interface may tightly link products with specific retailers, as shown in for example in the branded search results of diagram 600 in FIG. 6, or the branded storefront of diagram 200 in FIG. 2. After the user surveys the contents of the shopping list, which may appear similar to diagram 400 of FIG. 4, the user may decide to complete the transaction by placing an order for the contents of the shopping list.

Thus, application 113 may provide mechanisms to allow the user to send the contents of the shopping list to a specific associated retailer. For example, retailer heading 442b may include an “Order” button, not shown in FIG. 4, in addition to the “Map” button. After the user clicks the “Order” button, an order may be sent via network 115 to a commerce system of the TARGET® retailer for the products shown in item listings 450d, 450e, and 450f. The order may then be fulfilled by in-store pick-up or alternatively by mail delivery, and the payment for the transaction may be completed at the store in person or by electronic prepayment. Further, in the case of in-store pick-up, directions may be provided on display 114 to help the user navigate to the store. if the user will be retrieving the products directly, then directions may also be provided to find the products within the store, such as by providing aisle numbers and store interior maps. While the purchase of tangible goods may comprise the most common transaction, alternative transactions may comprise product rentals, tickets, service contracts, or the purchase of intangible goods such as digital music, virtual currency, or account credits.

The disclosed interfaces thereby provide users of Internet access devices flexible access to online shopping circulars providing a rich set of functionality for a more engaging and streamlined shopping experience. By aggregating the data from all participating retailers and presenting the circular data in a friendly, intuitive, and flexible format, users can quickly locate items and promotions of interest while retailers can increase foot traffic, brand recognition, and expand marketing outreach. By linking the online shopping circulars with online content such as news and entertainment media applications, a welcome additional stream of revenue can be secured for content providers to enable the continued provision of high quality content in the Internet age.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A device providing a user interface for navigating online shopping circulars, the device comprising:
a processor configured to:
retrieve circular data including a plurality of circulars associated with a plurality of retailers offering a plurality of products, wherein each of the plurality of circulars include a plurality of promotions for a subset of the plurality of products;
present, on a display, the circular data arranged by sorting parameters;
receive a request to obtain a first product in response to the presenting; and
initiate a transaction for the first product with a first retailer from the plurality of retailers.

2. The device of claim 1, wherein the sorting parameters comprise ordering the plurality of circulars by associated time periods of validity.

3. The device of claim 1, wherein the sorting parameters comprise ordering the plurality of retailers using bids gathered from the plurality of retailers.

4. The device of claim 1, wherein the sorting parameters comprise filtering the plurality of retailers by proximity to the device.

5. The device of claim 1, wherein the sorting parameters comprise filtering the circular data using a user defined search term.

6. The device of claim 1, wherein the sorting parameters comprise filtering the circular data using a selectable category.

7. The device of claim 1, wherein prior to the initiation the processor is further configured to:
present, on the display, a notification alert prior to an expiration of a first promotion associated with the first product.

8. The device of claim 1, wherein prior to the initiation the processor is further configured to:
present, on the display, a notification alert after a commencement of a first promotion associated with the first product.

9. The device of claim 1, wherein the processor is configured to initiate the transaction by submitting an order for the first product to a commerce system of the first retailer.

10. The device of claim 1, wherein the processor is configured to initiate the transaction by providing directions on the display to assist in locating the first product in a physical store of the first retailer.

11. A method of providing a user interface for navigating online shopping circulars, the method comprising:
retrieving circular data including a plurality of circulars associated with a plurality of retailers offering a plurality of products, wherein each of the plurality of circulars include a plurality of promotions for a subset of the plurality of products;
presenting, on a display, the circular data arranged by sorting parameters;
receiving a request to obtain a first product in response to the presenting; and
initiating a transaction for the first product with a first retailer from the plurality of retailers.

12. The method of claim 11, wherein the sorting parameters comprise ordering the plurality of circulars by associated time periods of validity.

13. The method of claim 11, wherein the sorting parameters comprise ordering the plurality of retailers using bids gathered from the plurality of retailers.

14. The method of claim 11, wherein the sorting parameters comprise filtering the plurality of retailers by proximity to the device.

15. The method of claim 11, wherein the sorting parameters comprise filtering the circular data using a user defined search term.

16. The method of claim 11, wherein the sorting parameters comprise filtering the circular data using a selectable category.

17. The method of claim 11 further comprising, prior to the initiation:
presenting, on the display, a notification alert prior to an expiration of a first promotion associated with the first product.

18. The method of claim 11 further comprising, prior to the initiation:
presenting, on the display, a notification alert after a commencement of a first promotion associated with the first product.

19. The method of claim 11, wherein the initiation comprises submitting an order for the first product to a commerce system of the first retailer.

20. The method of claim 11, wherein the initiation comprises providing directions on the display to assist in locating the first product in a physical store of the first retailer.
